(19) United States
(12) Patent Application Publication
(10) Pub. No.: US 2025/0054496 A1
(43) Pub. Date: Feb. 13, 2025

(54) METHOD AND APPARATUS FOR FIXING A VOICE QUERY

(71) Applicant: InterDigital CE Patent Holdings, SAS, Paris (FR)

(72) Inventors: Thomas Morin, Saint-Gregoire (FR); Philippe Schmouker, Betton (FR); Sylvain Lelievre, Montgermont (FR)

(21) Appl. No.: 18/719,963

(22) PCT Filed: Nov. 17, 2022
(86) PCT No.: PCT/EP2022/082290

§ 371 Date: Jun. 14, 2024

(30) Foreign Application Priority Data
Dec. 16, 2021 (EP) 21306793.7
Dec. 16, 2021 (EP) 21306794.5
Dec. 16, 2021 (EP) 21306795.2

(51) Int. Cl. G10L 15/22

(52) U.S. Cl. CPC G10L 15/22; G10L 2015/221; G10L 2015/223

(57) ABSTRACT

A voice-controlled device adapted to submit textual queries recognized from voice queries spoken by a user provides an intermediate validation step before the submitting the query, allowing to check, cancel or fix the voice query with the voice. The system is particularly adapted to situations where the user cannot make use of his hands.

### TECHNICAL FIELD

At least one of the present embodiments generally relates to voice control and more particularly to a method for fixing a voice query using additional voice inputs.

### BACKGROUND

Voice-control is generally referring to the ability for a human user to express a command, or more generally a query, using his voice. The user starts the capture of her/his voice and when the voice-capture is stopped, the recorded voice signal is converted into a textual query using a speech-to-text module, the textual query is parsed, the resulting query is submitted to an external server or to another device and finally an action is executed (as shown in the example of FIG. 1), generating a result hopefully corresponding to the original user intent.

Depending on the type of query, the result of the query may be displayed on a screen (for example a query such as “what's the weather tomorrow in Paris?”) or result into modification of the user's environments (for example a query such as setting the lights on, closing the shutters, setting the oven to 200 degrees, setting the cruise control to 85). Voice-control may be used as a shortcut when typing the equivalent request is too long or complex or for performing a search or an action when the user hands cannot be used.

In conventional systems, once the voice capture has ended, the system parses the final text from the speech-to-text module and immediately applies the textual query (if recognized as a valid request). This may lead to a disappointing user experience when the textual query does not correspond to the spoken query. Indeed, one issue with voice control is that the environment, the capture, the speech-to-text module as well as the user's expression may not be perfect (for example a noisy environment or a bad pronunciation by the user or an erroneous recognition by the speech-to-text module) and thus may lead to incorrect word recognition. Therefore, the recognized textual query may be different from the expressed voice query. In conventional systems, the user may not be able to cancel or fix his request before the query is submitted. This is particularly problematic when the textual query corresponds to a direct command that modifies the user's environment (ex: “switch off the lights”). In this case, the user has no other solution than entering a new command to revert the operation (“switch the lights on”). Such misunderstanding between the user and the system may bother the user and everyone around him.

Embodiments described hereafter have been designed with the foregoing in mind.

### SUMMARY

According to embodiments, a voice-controlled device adapted to submit textual queries recognized from voice queries spoken by a user provides an intermediate validation step before submitting the query, allowing to fix the voice query using the voice. The system is particularly adapted to situations where the user cannot make use of his hands.

A first aspect of at least one embodiment is directed to a method comprising obtaining a first voice input corresponding to a captured spoken query, performing text recognition of the first voice input, providing display of a recognized textual query corresponding to the first voice input, obtaining further voice inputs comprising a command directed to fixing the first voice input and parameters for fixing the first voice input, performing text recognition of the further voice inputs, modifying the recognized textual query according to the recognized text of the further voice inputs, providing display of a modified recognized textual query, obtaining a new voice input corresponding to a captured validation command, and providing the modified recognized textual query.

A second aspect of at least one embodiment is directed to an apparatus comprising a processor configured to obtain a first voice input corresponding to a captured spoken query, perform text recognition of the first voice input, provide display of a recognized textual query corresponding to the first voice input, obtain further voice inputs comprising a command directed to fixing the first voice input and parameters for fixing the first voice input, perform text recognition of the further voice inputs, modify the recognized textual query according to the recognized text of the further voice inputs, provide display of a modified recognized textual query, obtain a new voice input corresponding to a captured validation command, and provide the modified recognized textual query.

In a variant embodiment of first and second aspects, an association is performed between a word of the recognized textual query and an identifier and wherein the association is visually represented by graphical elements or by a relative positioning of a representation of the identifier towards the position of the word as displayed.

In a variant embodiment of first and second aspects, the further voice inputs comprises a selection of at least one word in the recognized textual query through the associated identifier and wherein the modification of the first input is related to the selected at least one word.

In a variant embodiment of first and second aspects, the modification is selected amongst one of retrying a further voice capture of at least one word, spelling of at least one word or writing of at least one word.

According to a third aspect of at least one embodiment, a computer program comprising program code instructions executable by a processor is presented, the computer program implementing at least the steps of a method according to the first aspect.

According to a fourth aspect of at least one embodiment, a computer program product which is stored on a non-transitory computer readable medium and comprises program code instructions executable by a processor is presented, the computer program product implementing at least the steps of a method according to the first aspect.

### BRIEF DESCRIPTION OF THE DRAWINGS

FIG. 1 illustrates examples of screens corresponding to an interaction for a voice query using prior art systems.

FIG. 2 illustrates a block diagram of an example implementation of a user device according to embodiments.

FIGS. 3A, 3B, 3C and 3D illustrate an example flowchart of a process for fixing a voice query according to at least one embodiment.

FIG. 4 illustrates examples of screens corresponding to an interaction related to validating a recognized textual query according to at least one embodiment.

FIG. 5 illustrates examples of screens corresponding to an interaction related to fixing a recognized textual query according to at least one embodiment.

FIG. 6 illustrates examples of screens corresponding to an interaction related to spelling a word of a recognized textual query according to at least one embodiment.

FIG. 7 illustrates examples of screens corresponding to an interaction related to completing a recognized textual query according to at least one embodiment.

FIG. 8 illustrates examples of screens corresponding to an interaction related to pausing the voice query recognition according to at least one embodiment.

FIG. 9 illustrates different examples of word identifiers in a textual query according to embodiments.

FIG. 10 illustrates a further example of screen corresponding to an interaction related to fixing a recognized textual query according to at least one embodiment.

FIG. 11 illustrates examples of screens corresponding to an interaction related to changing the dictionary language for a at least one word of the recognized textual query according to at least one embodiment.

FIG. 12 illustrates an example of screen corresponding to an interaction related to selecting an alternative text for a recognized textual query according to at least one embodiment.

### DETAILED DESCRIPTION

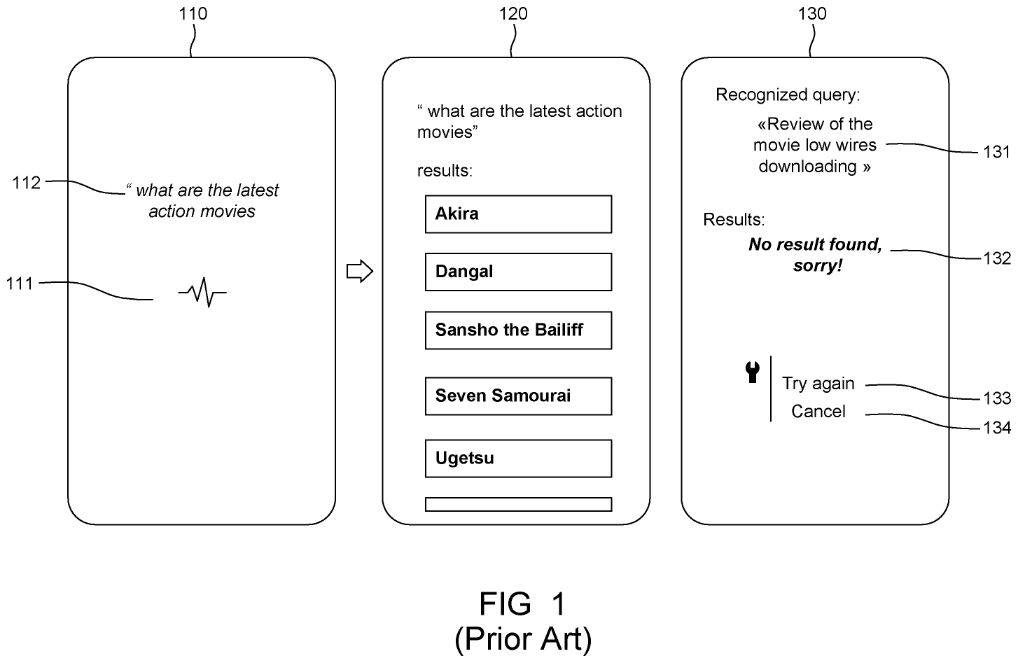

FIG. 1 illustrates examples of screens corresponding to an interaction for a voice query using prior art systems. Such voice query is generally initiated at user request and triggered by a user input action (physical button pressed or icon activated through touchscreen or spoken keyword), In response to such activation, the screen 110 is shown to the user while expressing the voice query. The graphical element 111 represents the voice activity during the voice capture and varies based on the level of signal. It tells the user that the system is capturing his voice. The graphical element 112 represents the textual query that is currently recognized. It may be updated in real time while the user is speaking. When an end-capture event is detected, the recognized textual query is directly submitted and the results are displayed in the screen 120, showing a list of titles of action movies and thus answering correctly to the user's request.

However, as introduced before, the recognition is not always perfect, so that the textual query determined from the voice query of the user may be comprise some errors. For example, the word “action” may be recognized as “Asian” due to noisy environment or bad pronunciation. In this case, since the query is directly submitted when an end-capture event is detected, the query may not correspond to the initial query but to another query. In this example, a list of titles of Asian movies may be displayed instead of the expected action movies.

The screen 130 represents another voice query of the user desiring to get of review of a French movie. The graphical element 131 represents the textual query that was recognized by the speech-to-text module. Since this module was configured to use the English language, it did not recognize the set of French words corresponding to the title of the movie, i.e “le voyage dans la lune”. Indeed, these words sound like the set of English words “low wires downloading”. After obtaining this query and recognizing the textual query represented by the graphical element 131, the device provides the request and gets no result, as shown by the graphic element 132. At this stage, the only choice for the user are to try again 133 or cancel 134. Both options are not satisfying. Indeed, the user is aware of the difference of language and would like to make a correction, but no means are existing for that.

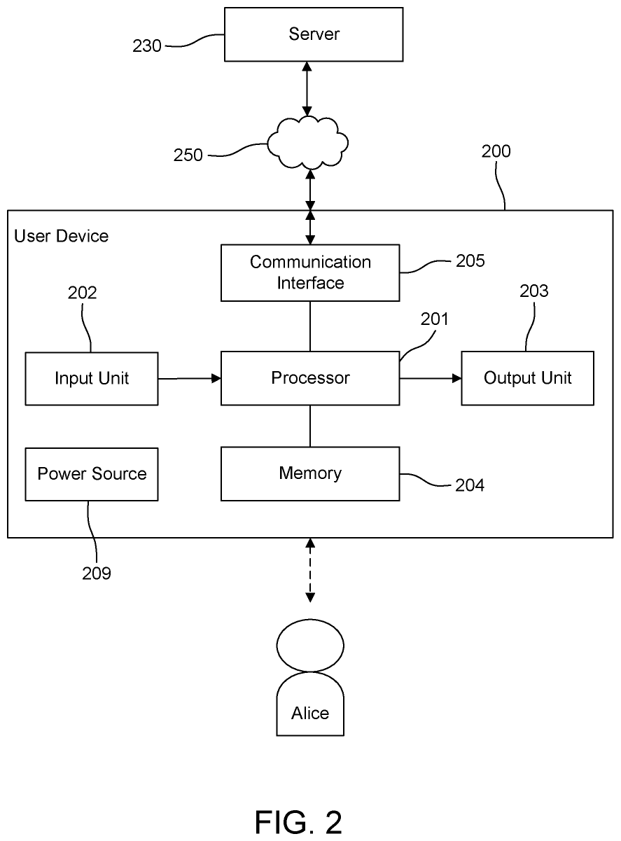

FIG. 2 illustrates a block diagram of an example implementation of a user device according to embodiments. Typical examples of user device 200 are smartphones, tablets, laptops, vehicle entertainment or control systems, head mounted displays, interactive kiosks, industrial equipment, or other computing devices. The user device 200 may be connected to a server device 230 or to other user devices through a communication network 250. The user device 200 may also operate independently of any other device.

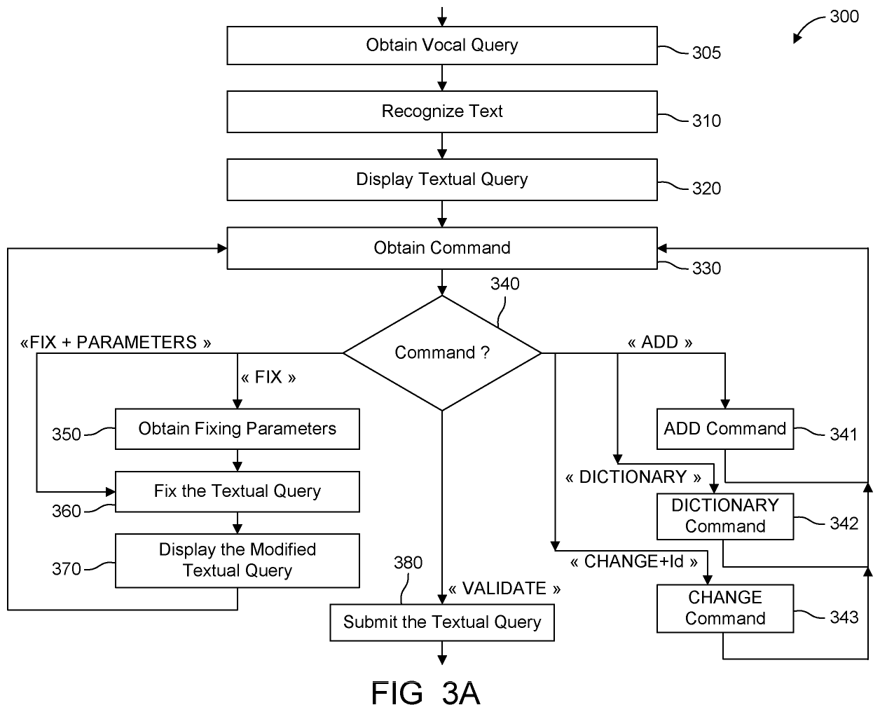

The user device 200 may include a processor 201 configured to implement the process of FIGS. 3A, 3B, 3C and 3D. The processor 201 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor may perform signal decoding, data processing, power control, input/output processing, and/or any other functionality that enables the user device 200 to provide appropriate functionalities to the user.

The processor 201 may be coupled to an input unit 202 configured to convey user interactions. Multiple types of inputs and modalities can be used for that purpose. A physical keyboard, physical buttons or a touch sensitive surface are typical examples of inputs adapted to this usage. The input unit 202 may also comprise a microphone configured to capture an audio signal recording the acoustic activity nearby the user device and especially capturing voice queries spoken by a human user. In addition, the input unit may also comprise a digital camera able to capture still picture or video.

The processor 201 may be coupled to an output unit 203 that may comprise a display unit configured to display visual data on a screen. Multiple types of display units can be used for that purpose such as a liquid crystal display (LCD) or organic light-emitting diode (OLED) display unit. The output unit 203 may also comprises an audio output unit configured to render sound data to be converted into audio waves through an adapted transducer such as a loudspeaker for example.

The processor 201 may be coupled to a communication interface 205 configured to exchange data with external devices. The communication may use a wireless communication standard to provide mobility of the User device, such as LTE communications, Wi-Fi communications, and the like. According to the type of device, other types of interfaces may be used such as an Ethernet interface adapted to be wired to other devices through appropriate connections. Also, an additional device, such as an internet gateway, may be used to enable the connection between the communication interface 205 and the communication network 250.

The processor 201 may access information from, and store data in, the memory 204, that may comprise multiple types of memory including random access memory (RAM), read-only memory (ROM), a hard disk, a subscriber identity module (SIM) card, a memory stick, a secure digital (SD) memory card, any other type of memory storage device. In other embodiments, the processor 201 may access information from, and store data in, memory that is not physically located on the User device, such as on a server, a home computer, or another device.

The processor 201 may receive power from the power source 209 and may be configured to distribute and/or control the power to the other components in the user device 200. The power source 209 may be any suitable device for powering the user device. As examples, the power source 209 may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

While the figure depicts the processor 201 and the other elements 202 to 209 as separate components, it will be appreciated that these elements may be integrated together in an electronic package or chip. It will be appreciated that the user device 200 may include any sub-combination of the elements described herein while remaining consistent with the embodiments.

The processor 201 may further be coupled to other interfaces, peripherals or units not depicted in FIG. 2 which may include one or more software and/or hardware modules that provide additional features, functionality and/or wired or wireless connectivity. For example, the processor may be coupled to a universal serial bus (USB) port, a vibration device, a television transceiver, a hands free headset, a Bluetooth® module, a frequency modulated (FM) radio unit, a digital music player, a media player, a video game player module, an Internet browser, and the like.

Additionally, in at least one embodiment, the user device 200 does not directly include the input unit 202 and/or the output unit 203 but is connected to external input unit or output unit for example through the communication interface 205. Typical examples of such devices are a desktop computer connected to an external keyboard, mouse, microphone, camera and display screen or a set top box connected to a television and controlled by a remote control.

The user device 200 may comprises a speech-to-text module not depicted in the figure, for example implemented as a dedicated hardware module or as software module executed by the processor 201, or may rely on an external speech-to-text module hosted for example on an external server connected through the communication network 250.

FIGS. 3A, 3B, 3C and 3D illustrate examples of flowcharts of processes for fixing a voice query according to at least one embodiment. These processes 300, 341, 342 and 343 are typically implemented in a user device 200 of FIG. 2 and more particularly executed by the processor 201 of this device.

In step 305, the processor obtains a voice query. This step starts with an activation of the voice listening function. This may be done using different means such as, for example, a physical button pressed by the user (for example a push-to-talk button) or the recognition of a predetermined keyword (for example “ok google” for devices of the Google eco system) or the activation of a corresponding function on a touchscreen (for example activating a microphone icon on the screen of a smartphone). The recording of an audio signal captured through a microphone of the input unit 202 of user device 200 of FIG. 2 is started until the voice capture is stopped (for example when an end-capture event is detected). Indeed, voice-controlled system conventionally react to end-capture events triggered by one of the following methods.

A first method is to use a period of silence, either audio silence, meaning a low intensity of the captured audio signal during a certain time (using a threshold for the intensity that may be dynamically evaluated) or word-silence, meaning the speech-to-text has not recognized any word during a certain delay. The latter technique provides better results than audio-silence when operating in noisy environment. A second method is to use a stop keyword (i.e. a predetermined word such as “stop”), that cannot be part of the request, is recognized by the system and leads to triggering an end-capture event. A third method is to use a non-voice related event such as pressing or releasing a physical button, interacting with a touchscreen interface, performing a gesture or other techniques.

When the end-capture event is detected, in step 310, the recorded audio signal representing the voice query is then provided to the speech-to-text module in order to recognize the text corresponding to the recorded audio signal. This speech-to-text module generates a recognized textual query that corresponds to the voice query expressed by the user between the activation of the voice query mechanism and the detection of the end-capture event and recognized by the speech-to-text module. At this step 310, the recorded audio signal also may be stored for further reuse.

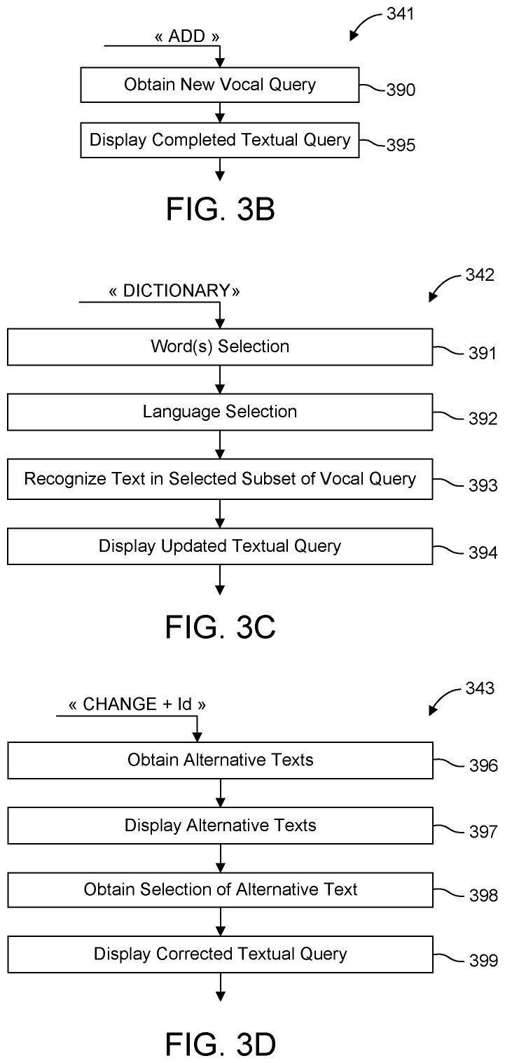

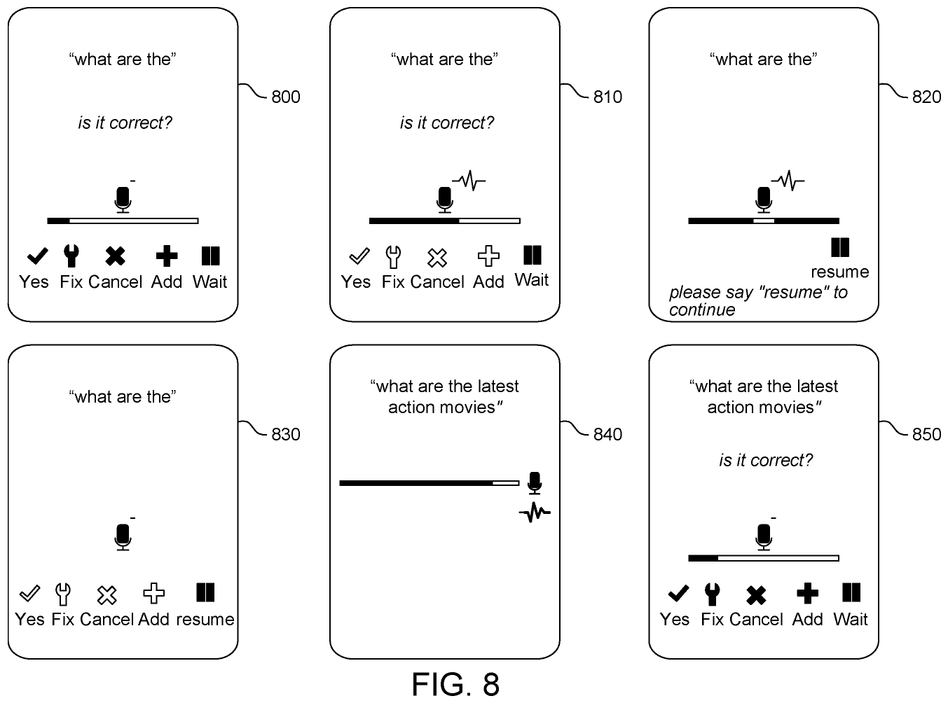

In step 320, the processor displays the recognized textual query on the screen of the user device 200 (or alternatively on a screen of a device connected to the user device 200). This allows the user to verify that the recognized textual query corresponds to the voice query previously expressed. A voice query generally comprises a plurality of words. Some identifiers are associated to each word of the recognized textual query so that the user can further identify a word (or a set of words) when fixing the query. Typical examples of identifiers are numbers or letters. These identifiers are displayed so that the user understands the association, as shown in FIG. 9, for example beside each word or under each word or more generally in proximity of each word. In addition to the textual query, the processor also displays the possible operations, for example allowing to validate, fix, cancel, complete or pause the query, as illustrated in FIG. 4.

In step 330, the processor obtains a command. In at least one embodiment, this command is also expressed as a voice query and thus uses the same elements (activation of the voice listening function, audio signal recording, end-capture event detection, speech-to-text module generating the corresponding text). In another embodiment based on multimodal input, the command is selected by other means such as selecting the displayed corresponding icon on a touchscreen or activating the command by pressing a physical button.

In step 340, when the command corresponds to a validation in branch “VALIDATE” (corresponding to the entry “yes” in screen 420 of FIG. 4), the processor jumps then to step 380 to submit the recognized textual query. This means that the user confirmed that the textual query corresponds to his voice query.

In step 340, when the command corresponds to a fixing request in branch “FIX” (corresponding to the entry “fix” in screen 420 of FIG. 4), then this means that the user considers that the system did not correctly interpret the voice query and that some correction is required. In this case, the processor jumps to step 350.

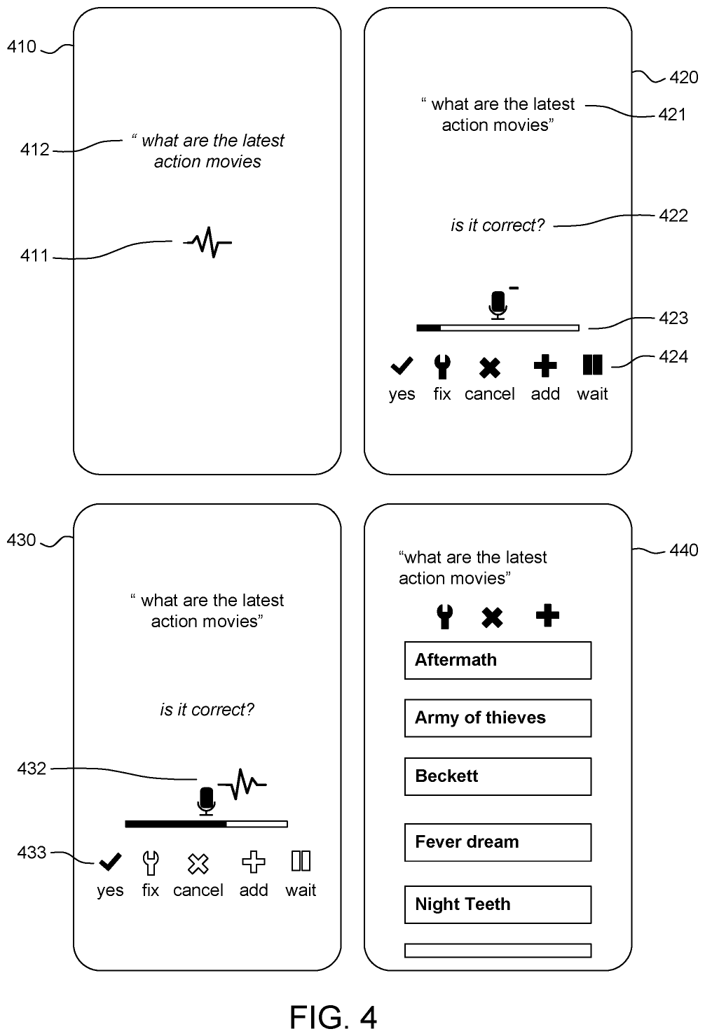

In step 340, the command may correspond to a fixing request together with the fixing parameters (branch “FIX+PARAMETERS”). One example of such request is “replace four by lights”, requesting to replace the fourth word of the displayed recognized textual query by the word “lights” (See FIG. 5). In this case, the processor jumps to step 360.

For the sake of readability, not all events related to the step 340 are represented on the FIG. 3A. The “ADD” command is described in FIG. 3B, the “DICTIONARY” command is described in FIG. 3C, and the “CHANGE” command is described in FIG. 3D.

In step 340, when the command corresponds to a cancel request (corresponding to the entry “cancel” in screen 420 of FIG. 4), the process 300 is exited and may be restarted later.

In step 340, when the command corresponds to a request for completing the query (corresponding to the entry “add” in screen 420 of FIG. 4), the processor jumps to step 341 that is detailed in FIG. 3B. In step 390, the processor obtains a new vocal query and will append the recognized new textual query to the former textual query in step 395. This situation may be interesting for example in the case where an end-capture event is detected before the user completed the voice query. Such situation may occur for example due to an external event such as a baby falling onto the floor or a traffic light turning orange on the road in a vehicle entertainment system application. In this case, the completion option allows to complete the query with the missing words rather than starting again from the beginning.

In step 340, when the command corresponds to a request for pausing the query (corresponding to the entry “wait” in screen 420 of FIG. 4), the process is on hold and waits until the user ends the pause. This situation may be interesting for example in the case where the user was unexpectedly interrupted while providing the voice query and thus, prefers to defer the completion of the query at a later moment because of the urgent situation. In this case, making the voice query is an action of secondary importance.

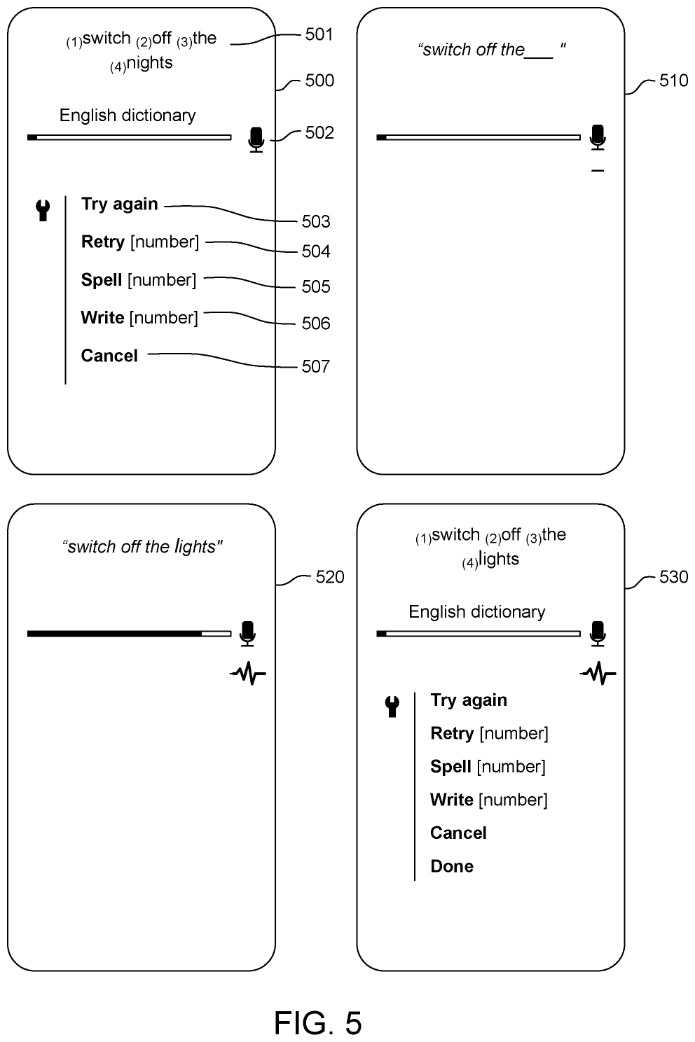

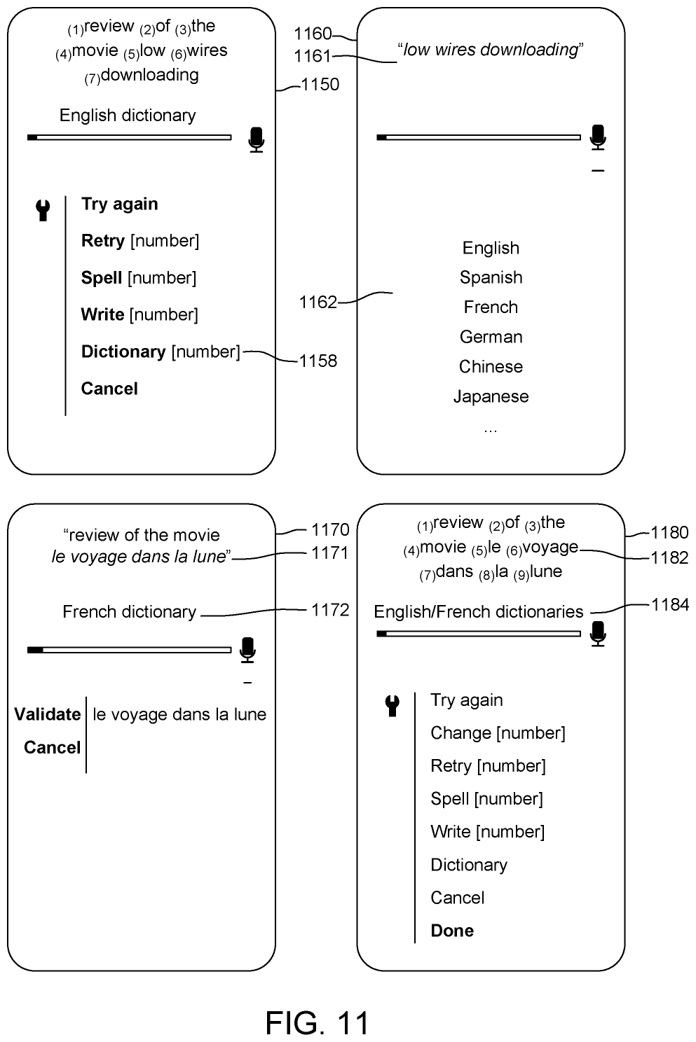

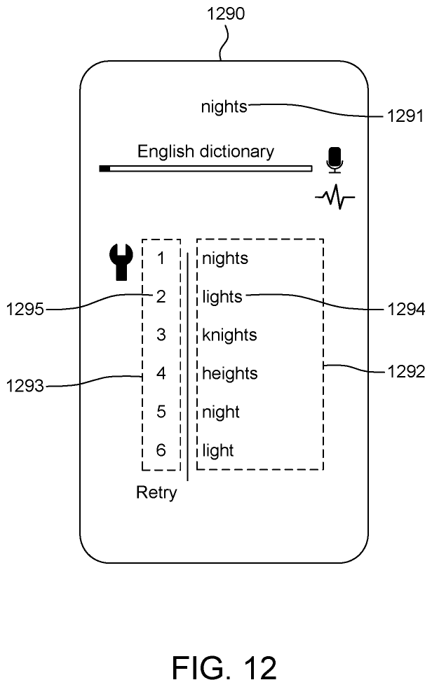

In step 350, the processor obtains the fixing parameters. Different methods for fixing the query may be used. Some examples of fixing techniques are detailed below in FIG. 5, FIG. 6, FIG. 11 and FIG. 12. They include at least retrying or spelling one or more of the words of the textual query, changing the dictionary of the query or changing the query by selecting an alternative word. The words involved by this fix are identified through their associated identifiers and are selected using these associated identifiers. First, the fixing method and the words involved are selected. Then the words involved are modified according to the fixing method, for example using a new voice query to speak the new words.

In step 360, the processor modifies the recognized textual query according to the fix parameters. For example, if the command was about fixing the first word, the first word is replaced by a newly spoken first word.

In step 370, the processor displays the modified textual query and jumps back to step 330 where the user may validate the modified textual query or perform a further fix.

In step 340, when the command corresponds to a request for changing the dictionary of the query (or of a subset of the query), the processor jumps to step 342 that is detailed in FIG. 3C.

In step 391, the processor obtains a selection of words of the query. When no word (or range of words) is selected, then the whole query is selected, corresponding to a change of dictionary language for the full query. Then, in step 392, the processor obtains the language to be used for the selected word or set of words. The recognition language of the speech-to-text module is then changed to the selected language. Although the command is labeled as dictionary, it not only changes the dictionary but also the grammar as well as any parameter related to the selection of a language to be recognized. In step 393, a subset of the recorded voice signal (previously stored for further use) corresponding to the selected word or set of words is provided to the speech-to-text module in order to recognize the selected text in the selected language. An updated version of the textual query is displayed, in step 394. This updated textual comprises the formerly recognized query wherein the selected text has been replaced by an updated version in the selected language.

In step 340, when the command corresponds to a request for changing a word of the recognized textual query (by selecting an alternative word), the processor jumps to step 343 that is detailed in FIG. 3D. Such request also includes a selection of the incorrect word of the recognized textual query, expressed by the associated identifier. An example of such request is “change 3”. This would request the processor to propose alternative words for the third word of the recognized textual query. In step 396, a subset of the recorded voice signal (previously stored for further use) corresponding to the selected word is provided to the speech-to-text module in order to perform the recognition of the selected text and provide the list of alternative texts. This list may be ordered according to decreasing values of the confidence. This list of alternative texts is displayed, in step 397, together with the corresponding order in the list. For example, the first one will be associated with the number ‘1’. In step 398, the selection of one of the alternative text is obtained from the user. This is done by telling the number associated to the alternative text, for example ‘2’ for the second alternative text of the list. In step 399, the corrected textual query is displayed, and the processor jumps to step 330 to obtain validation of the corrected textual query or further fixing.

A correspondence is established between the recorded audio signal and the recognized text, more particularly between words of the recognized text and extracts of the recorded audio signal. This is done using conventional time-stamping techniques where a recognized word is associated to a temporal subset of the audio recording. For example, the third word is associated to the range [0.327-0.454], expressed in seconds, meaning that the audio subset corresponding to this word starts 327 milliseconds after the beginning of the recording and ends at the 454 millisecond timestamp. Such feature is conventionally provided by speech-to-text modules. This allows to provide to the speech-to-text module only an extract of the initial voice query and thus to correct a single word (or a set of words).

As described below, a group of consecutive words may also be selected to be replaced by an alternative text. This may be required for example when the speech-to-text misunderstood one word as a plurality of words. For example, “screenshot” could be recognized as “cream shop”. In this case, the user should select both words to perform the recognition again on the corresponding extract of the audio corresponding to both recognized words “cream shop”.

The embodiments above have been described using a display of provide feedback to the user. In an alternate embodiment, instead of displaying text, the feedback to the user is provided by an audio output. This could be particularly interesting in industrial environments or outdoors, when the visibility of a display is not satisfying. In such embodiment, all text displays are therefore replaced by audio feedbacks. In this case, the association between words and identifier is also expressed by an audio message.

FIG. 4 illustrates examples of screens corresponding to an interaction related to validating a recognized textual query according to at least one embodiment. The screen 410 is similar to the screen 110 of FIG. 1 and comprises similar elements. A graphical element 411 represents the voice activity during the voice capture. This element 411 varies based on the level of signal to inform the user that the system is currently capturing his voice. The graphical element 412 represents the textual query that is being recognized. It may be updated in real time while the user is speaking or only after an end-capture event is detected. According to embodiments, when an end-capture event is detected, the screen 420 is displayed and shows the recognized textual query 421, requests a user input in response to a question 422 corresponding to one of the commands 424 presented. The element 423 informs the user that the command may be entered using her/his voice. The set of commands 424 presented allow the user respectively to validate (“yes”), to fix (“fix”), to cancel (“cancel”), to complete (“add”) or to pause (“wait”) the recognized textual query 421. When in this screen 420, the user responds to the question 422 by speaking something, the screen 430 is displayed showing that the user wants to provide a voice input. In this case, the element 432 is animated to inform the user that the processor is currently recording the voice input. After an end-capture event is detected, when the voice input corresponds to one of the commands, the corresponding graphical element is highlighted, and the corresponding function is triggered. The screen 430 shows an example where the user validates the recognized textual query 421 by saying “yes”. The validation command is recognized as shown by element 433. In this case, the query is submitted, and the result is displayed, leading for example here to a list of the latest action movies as illustrated in screen 440.

FIG. 5 illustrates examples of screens corresponding to an interaction related to fixing a recognized textual query according to at least one embodiment. It corresponds to a situation where the textual query is recognized as being “switch off the nights” instead of “switch off the lights” as spoken by the user. The screen 500 is triggered by the user requesting to fix his request, for example by saying the word “fix” in screen 420 of FIG. 4. The screen 500 presents the recognized textual query 501 (with a recognition error on the fourth word), a graphical element 502 informing the user that the command may be enter using her/his voice and elements corresponding to a set of fixing commands comprising for example “try again” 503, “retry” 504, “spell” 505, “write” 506 and “cancel” 507. In the example of screen 500, recognized textual query 501 is incorrect since the last word was not recognized correctly and some fixing is required.

The “try again” command, represented by the graphical element 503, allows to clear the recognized textual query and start again the process 300 of FIG. 3 from fresh. This command is particularly helpful when the recognized textual query 501 is very far away from the voice input. This may happen for example in temporarily noisy environments (a loud motorcycle passing by or a shouting kid rushing down the stairs).

The “retry” command, represented by the graphical element 504, allows to replace one of the words by a new word entered using a voice input. An identifier allows to select the word to be replaced. For example, by entering “retry 4”, the user informs that the word corresponding to the identifier ‘4’ (in this case the fourth word “nights”) needs to be selected for the fixing operation. Indeed, this word has not been recognized correctly by the system and another try needs to be done. The fourth word is then cleared out from the recognized textual query as illustrated in screen 510 and replaced by a new word or set of words entered using the next voice input as illustrated in screen 520, for which the user entered the voice input “light” that was successfully recognized by the speech-to-text module as “lights”. When an end-capture event is detected, the screen 530 is shown, comprising the modified textual query where the erroneous word “nights” has been replaced by the corrected word “lights”. From that screen, the user may validate and submit the query using the “done” command. This will submit the query and display the result as shown in screen 440 of FIG. 4.

The “spell” command, represented by the graphical element 505, allows to spell one of the words of the recognized textual query 501. For example, by entering “spell 4”, the user informs that the fourth word has not been recognized correctly by the system and the word will be entered using spelling, as further illustrated in FIG. 6.

The “write” command, represented by the graphical element 506, allows to enter one of the words (or a set of words) of the recognized textual query 501 using writing means such as a touchscreen or keyboard or using any other conventional no-voice related technique for typing text.

The “cancel” command, represented by the graphical element 507, allows the user to completely exit the voice querying mechanism.

Alternatively, instead of fixing a single word, the user may specify a range of words to be fixed. This is particularly adapted in case of long queries (for example, entering an address). This can be done by selecting a range of identifiers associated to the range of words to be fixed. In the example of using the “retry” command”, by entering the voice input “retry 3 to 5”. This will allow replacing three words from the third position to the fifth position. The selection of multiple words is done similarly to the other commands (i.e. using the voice).

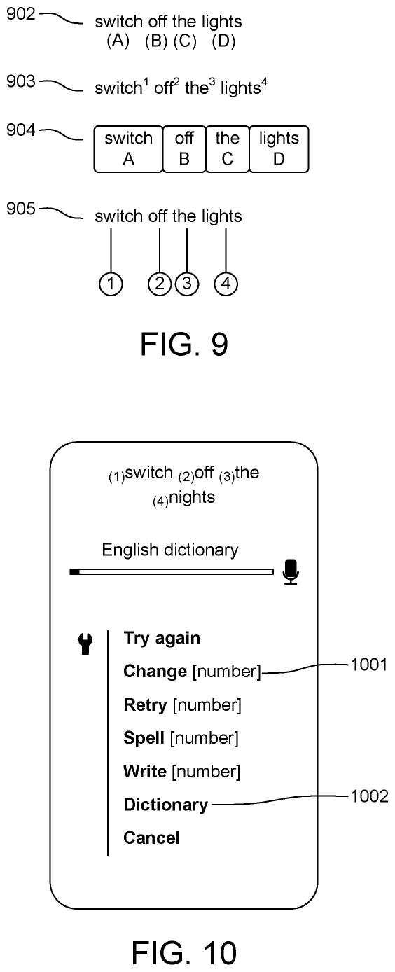

Additional fixing mechanisms may be proposed as illustrated by elements 1001 and 1002 of FIG. 10 described below for example introducing the “change” and “dictionary” fixing methods.

FIG. 6 illustrates examples of screens corresponding to an interaction related to spelling a word of a recognized textual query according to at least one embodiment. The screen 600 is triggered by the user requesting to fix his request by spelling the fourth word, i.e. by entering the voice input “spell 4” from screen 500 of FIG. 5. The screen 600 presents the recognized textual query 601 from which the fourth word was cleared out (in other words removed from display), a graphical element 602 informing the user that the command may be enter using her/his voice, a graphical element 603 representing the letters of the alphabet and characters that may be entered. Also some other graphical elements inform the user that s/he may also erase a letter (“backspace” 604), return to the previous screen (“exit” 605) or validate the corrected textual query (“done” 606). The screen 610 shows the result of the user entering the voice input “L”, in other words speaking the letter “L”, from the screen 600. After entering the first letter, the user enters the other letters of the word “lights” and obtains the screen 620 where s/he may validate the corrected textual query by speaking “done”.

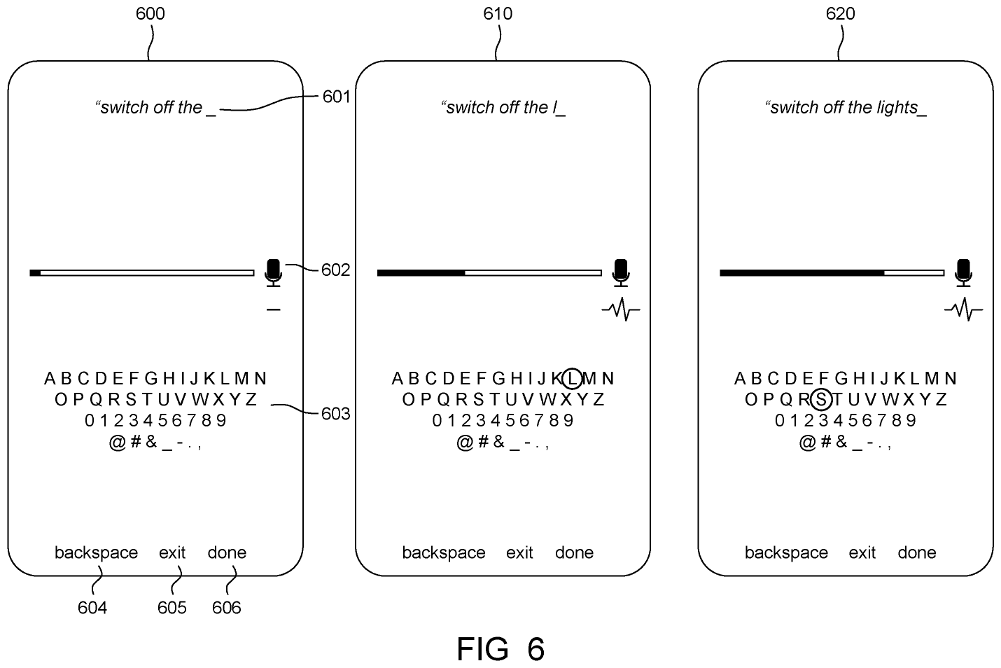

FIG. 7 illustrates examples of screens corresponding to an interaction related to completing a recognized textual query according to at least one embodiment. The screen 700 is triggered by the detection of an end-capture event while the user entered a voice input. The screen 700 presents an incomplete recognized textual query 701. At this stage, the system does not understand that the query is incomplete, however it is obvious for the user. Such situation may appear for example when the user is unexpectedly interrupted during the process of speaking out the voice query by a more important event (for example a traffic light turning orange on the road in a vehicle entertainment system application). In such situation, after the unexpected event is resolved, the user requests completing the query for example by speaking the word “add”. Recognizing this action, as shown in screen 710, will trigger the screen 720 where the former recognized textual query is shown and is completed by the user speaking the remaining words of the desired query. When an end-capture is detected, the corrected recognized textual query is shown as illustrated in screen 730 and the user may validate the query or perform other actions.

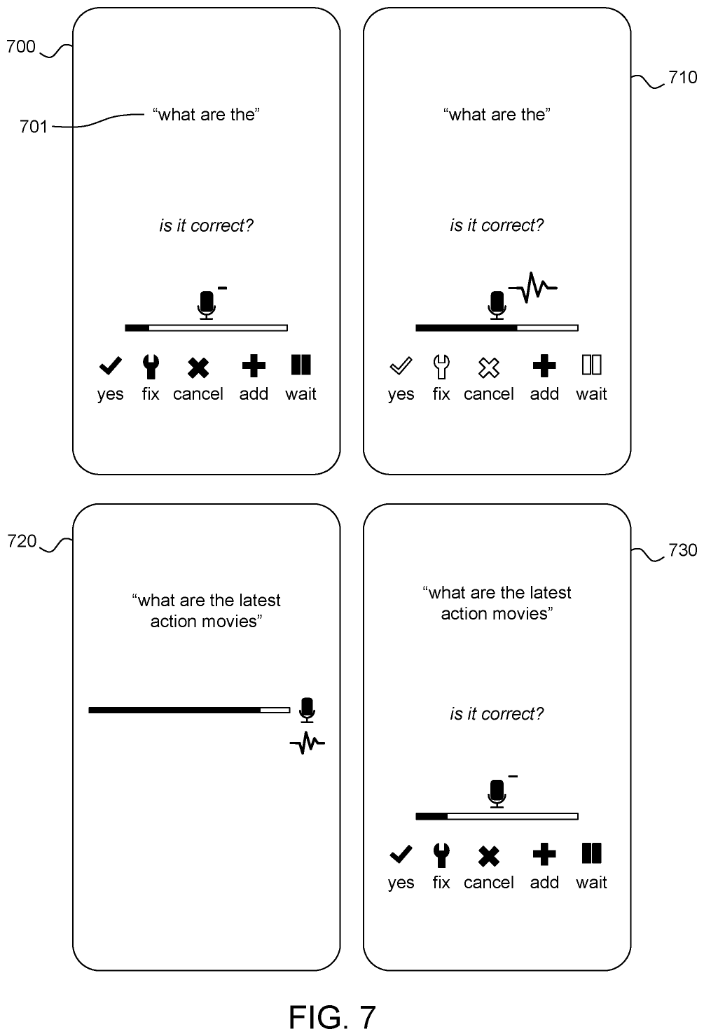

FIG. 8 illustrates examples of screens corresponding to an interaction related to pausing the voice query recognition according to at least one embodiment. The situation is somehow similar to the unexpectedly interruption discussion in relation with FIG. 7, with the difference that the user anticipates that the interruption may require more time. This is the case for example when a phone is ringing, or someone knocks on the door. The screen 800 illustrates a voice query entered by the user and interrupted. An end-capture event is detected and the screen 810 is displayed. The user noticing the issue and needing some time to solve the interruption then asks the system to pause (by speaking the word “wait”) and the screen 820 is shown. When the user is ready to continue, then s/he requests to resume the interaction by speaking the word “resume”. When this word is recognized, as shown in screen 830, the query may be completed by the user speaking the remaining words of the desired query as illustrated in screen 840. When an end-capture is detected, the corrected recognized textual query is shown as illustrated in screen 850 and the user may validate the query or perform other actions.

FIG. 9 illustrates different examples of word identifiers in a textual query according to embodiments. The example textual query is comprising the four following words: “switch off the lights”. The different groups of graphical elements illustrate different examples of representation allowing to perform an association between a word and an identifier. The group 901 shows a first example of identifier based on a number positioned before the associated word. The group 902 shows a second example of identifier based on a letter positioned below the associated word. The group 903 shows a third example of identifier based on a number positioned as an exponent at the upper right side of the associated word. The group 904 shows a fourth example of identifier based on a letter visually grouped with the associated word within a box. The group 905 shows a fifth example of identifier based on a circled number visually linked with the associated word though a line. Other type visual indicators may be used such as icons or colors for example. Other arrangements between a word and a corresponding identifier may be used to provide such association.

FIG. 10 illustrates a further example of screen corresponding to an interaction related to fixing a recognized textual query according to at least one embodiment. This screen is an alternative screen to the screen 500 of FIG. 5. It proposes additional fixing techniques related to changing a word 1001 or selecting a dictionary 1002. Selecting a dictionary 1002 is described in FIGS. 3C and 11. Changing a word 1001 is described in FIGS. 3D and 12.

FIG. 11 illustrates examples of screens corresponding to an interaction related to changing the dictionary language for a at least one word of the recognized textual query according to at least one embodiment. The screen 1150 corresponds to the situation where the recognized is incorrect because some words of the voice query are in English language (“review of the movie”) while the other words are in French language (“le voyage dans la lune”). Such situation is common when dealing with international entertainment content. The issue here is that the speech-to-text module is trying to recognize the French words while being configured to recognize English language. Thus, it will propose English words that match the best with the audio recording, but this generally results into unsatisfying results in term of recognition, as shown in the example. In this case, the user will request the dictionary fixing command 1158 with a selection of a range of (badly) recognized words, here the words 5, 6, and 7. Such a fixing command can be triggered by entering the voice input “dictionary 5 to 7”. The processor then displays the screen 1160 that shows the selected words 1161 from the recognized textual query and lists the available languages 1162. The user selects one of the languages (step 392 of FIG. 3C). The processor then extracts the audio sequence corresponding to the selected words from the recorded audio signal that was previously stored (in step 305 of FIG. 3) and provides it to the speech-to-text module for recognition. The recognized text 1171 is optionally displayed in screen 1170, where it is mentioned that the French dictionary 1172 was used. In the optional screen 1170, the user may validate or cancel. In the latter case, the processor returns to screen 1150. When the user validated, the corrected textual query is displayed as illustrated in screen 1180 for example, where the graphical element 1182 show the corrected textual query, the element 1184 shows that multiple dictionaries were used. The set of fixing tools mentioned earlier in FIGS. 3A, 3B, 3C, 3D, 5 and 10 are also available again at this stage. When the corrected textual query corresponds to the desired one, the user may validate it by speaking “done”. Another fixing mechanism may be used before such validation.

As previously mentioned, the recorded audio signal corresponding to the initial voice query (305 of FIG. 3A, equivalent to 111 in FIG. 1) is stored for further use. This provides a much more convenient user experience since the user is not requested to repeat again the same words. The device stored them for further use.

A correspondence is established between the recorded audio signal and the recognized text, more particularly between words of the recognized text and extracts of the recorded audio signal. This is done using conventional time-stamping techniques where a recognized word is associated to a temporal subset of the audio recording. For example, the third word is associated to the range [0.327-0.454], expressed in seconds, meaning that the audio subset corresponding to this word starts 327 milliseconds after the beginning of the recording and ends at the 454 millisecond timestamp. Such feature is conventionally provided by speech-to-text modules. This allows to provide to the speech-to-text module only an extract of the initial voice query and thus to correct a single word (or a set of words).

FIG. 12 illustrates an example of screen corresponding to an interaction related to selecting an alternative text for a recognized textual query according to at least one embodiment. The screen 1290 corresponds to a situation similar to the screen 500 of FIG. 5 where the sentence “switch off the lights” was incorrectly recognized, the fourth word being erroneously recognized as “nights”. In this case, the fixing method requested is to use the change option 1001 of FIG. 10. This is done by having the user speak “change 4” to indicate that it is requested to change the fourth word. This leads to the screen 1290 showing the erroneous word 1291 to be corrected, a list of alternate words 1292 and the corresponding identifiers 1293. For example, the identifier 1295 is associated to the word 1294. The user may express his selection of an alternate word by speaking the associated identifier, for example say ‘2’ to select the word “lights”. This action completes the correction and leads to a screen identical to the screen 530 of FIG. 5 where the word “nights” is replaced by the selected alternative “lights”.

Similarly than in FIG. 11, the recorded audio signal corresponding to the initial voice query (305 of FIG. 3A, equivalent to 111 in FIG. 1) is reused and provided to the speech-to-text module to generate the list of alternate words 1292. This provides a much more convenient user experience since the user is not requested to repeat again the same words. The device stored them for further use. It also requires the correspondence between the recorded audio signal and the recognized text, more particularly between words of the recognized text and extracts of the recorded audio signal, as introduced above with reference to FIG. 11.

All screen examples introduced above are controlled using voice input. However, the graphical elements may also be controlled by other means to ensure multimodality. For example, a user may use a touchscreen to activate the “cancel” graphical element of screen 420 of FIG. 4, which would result in cancelling the voice query.

Graphical elements are herein mostly represented as a combination of an icon and a word. In other embodiments still using the same principles, only the icon is presented or only the word.

Although some words are indicated on the screens to guide the user, the system may recognize other keywords that are synonyms or represent a similar concept. For example, in the screens of FIG. 6, the user may choose to say “erase” rather than “backspace” and will obtain the same result. The same goes for “change” that may be replaced by “alternate” for example or “dictionary that may be replaced by “language” for example. In general, validation may be also done by using the word “OK” (for example in screen 420 instead of “yes”, in screen 530 instead of “done”), except for the spelling screens of FIG. 6 where those letters would be recognized as individual letters and would be used to spell the word “ok”.

Reference to “one embodiment” or “an embodiment” or “one implementation” or “an implementation”, as well as other variations thereof, mean that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout the specification are not necessarily all referring to the same embodiment.

Additionally, this application or its claims may refer to “determining” various pieces of information. Determining the information may include one or more of, for example, estimating the information, calculating the information, predicting the information, or retrieving the information from memory.

Further, this application or its claims may refer to “accessing” various pieces of information. Accessing the information may include one or more of, for example, receiving the information, retrieving the information (for example, from memory), storing the information, moving the information, copying the information, calculating the information, predicting the information, or estimating the information.

Additionally, this application or its claims may refer to “receiving” various pieces of information. Receiving is, as with “accessing”, intended to be a broad term. Receiving the information may include one or more of, for example, accessing the information, or retrieving the information (for example, from memory or optical media storage). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

1-34. (canceled)

35. A method comprising:
performing a first text recognition of a first voice input representative of a captured spoken query;
providing display of a recognized textual query corresponding to the first voice input;
obtaining further voice inputs representative of a command directed to a selection of language for a selected subset of the recognized textual query;
performing a second text recognition of the selected subset of the recognized textual query using the selected language;
modifying the selected subset of the recognized textual query according to the recognized text; and
providing display of the modified textual query.

36. The method of claim 35, wherein an association is performed between a word of the recognized textual query and an identifier and wherein the association is visually represented by graphical elements or by a relative positioning of a representation of the identifier towards the position of the word when displayed on a screen.

37. The method of claim 36, wherein the first voice input is stored in a recorded voice signal, further comprising an association between a word and a corresponding subset of the recorded voice signal and wherein a subset of the recorded voice signal corresponding to words of the selected subset of the recognized textual query is used for the second text recognition using the selected language.

38. The method of claim 35 using a multimodal input, where the command directed to a selection of language is selected by selecting a corresponding icon displayed on a touchscreen.

39. The method of claim 35 using a multimodal input, where the command directed to a selection of language is selected by pressing a physical button.

40. An apparatus comprising a processor configured to:
performing a first text recognition of a first voice input representative of a captured spoken query;
providing display of a recognized textual query corresponding to the first voice input;
obtaining further voice inputs representative of a command directed to a selection of language for a selected subset of the recognized textual query;
performing a second text recognition of the selected subset of the recognized textual query using the selected language;
modifying the selected subset of the recognized textual query according to the recognized text; and
providing display of the modified textual query.

41. The apparatus of claim 40, wherein an association is performed between a word of the recognized textual query and an identifier and wherein the association is visually represented by graphical elements or by a relative positioning of a representation of the identifier towards the position of the word as displayed.

42. The apparatus of claim 41, wherein the first voice input is stored in a recorded voice signal, further comprising an association between a word and a corresponding subset of the recorded voice signal and wherein a subset of the recorded voice signal corresponding to words of the selected subset of the recognized textual query is used for the second text recognition using the selected language.

43. The apparatus of claim 40 using a multimodal input, where the command directed to a selection of language is selected by selecting a corresponding icon displayed on a touchscreen.

44. The apparatus of claim 40 using a multimodal input, where the command directed to a selection of language is selected by pressing a physical button.

45. An apparatus comprising a processor configured to:
performing a first text recognition of a first voice input representative of a captured spoken query;
providing display of a first recognized textual query corresponding to the first voice input;
obtaining further voice inputs representative of a command directed to a selection of language for the first recognized textual query;
performing a second text recognition of the first recognized textual query using the selected language;
modifying the recognized textual query according to the recognized text; and
providing display of the modified textual query.

46. The apparatus of claim 45, where a recorded voice signal corresponding to the first voice input is used for the second text recognition using the selected language.

47. The apparatus of claim 45 using a multimodal input, where the command directed to a selection of language is selected by selecting a corresponding icon displayed on a touchscreen.

48. The apparatus of claim 45 using a multimodal input, where the command directed to a selection of language is selected by pressing a physical button.

49. A non-transitory computer-readable storage medium having stored instructions that, when executed by a processor, cause the processor to perform the method of claim 35.
